(19) United States
(12) Patent Application Publication
(10) Pub. No.: US 2018/0293686 A1
(43) Pub. Date: Oct. 11, 2018

(54) Supply Chain Integrity Verification System and Method

(71) Applicant: The Charles Stark Draper Laboratory, Inc., Cambridge, MA (US)

(72) Inventor: Benjamin F. Lane, Sherborn, MA (US)

(21) Appl. No.: 15/945,813

(22) Filed: Apr. 5, 2018

Related U.S. Application Data
(60) Provisional application No. 62/482,494, filed on Apr. 6, 2017.

(51) Int. Cl. G06Q 50/28; G06F 17/30; H04L 9/32

(52) U.S. Cl. CPC G06Q 50/28; G06Q 2220/00; H04L 9/3239; G06F 17/30241

(57) ABSTRACT

A geo-location system determines location histories for geo-locator devices in shipments. The devices generate and store environmental measurements, which are retrieved and compared to data from an environmental conditions database to calculate location histories. The measurements generated by sensors of the devices are encrypted along with hashed iterations, using one-way hash functions, of unique seed numbers associated with each device. The series of hashed iterations are compared to independently calculated series to determine if the devices have been tampered with. Location histories of devices included in common shipments are compared to determine whether devices have been tampered with. The location histories are compared to the expected routes of the shipments to determine if shipments were diverted. The atmospheric pressure measurements recorded by devices in shipments sealed under constant pressure are analyzed to determine if the shipments were unsealed. Shipments are verified if no tampering or diversion is detected.

### RELATED APPLICATIONS

This application claims the benefit under 35 USC 119(e) of U.S. Provisional Application No. 62/482,494, filed on Apr. 6, 2017, which is incorporated herein by reference in its entirety.

### BACKGROUND OF THE INVENTION

The geo-location system described in U.S. Pat. No. 8,443,662 to Lane et al., entitled “GEO-LOCATION SYSTEMS AND METHODS BASED ON ATMOSPHERIC PRESSURE MEASUREMENT”, which is incorporated herein by reference in its entirety, includes a geo-locator device provided with an atmospheric pressure sensor. The geo-locator device continuously generates and stores environmental measurements (including atmospheric pressure measurements) and the time of those measurements. The measurements are then retrieved by a location processor, which calculates a location history for the device by comparing the measurements with data from an external atmospheric pressure database, such as the Rapid Update Cycle Surface Assimilation System maintained by the National Oceanic and Atmospheric Association, the Modern Era Retrospective—Analysis for Research and Applications maintained by the national Aeronautics and space Administration, and datasets maintained by the European Centre for Medium-Range Weather Forecasts. By using predetermined information such as the origin and/or final destination and a maximum speed of an object carrying the device, and by performing an iterative Bayesian procedure, these systems can determine the devices' location history. Applications for this system include shipping and law enforcement, among other examples.

### SUMMARY OF THE INVENTION

It would be desirable to improve the previously described geo-location system by providing a means of verifying the location history as calculated by the location processor, based on the atmospheric pressure measurements. Such a verification provides users with proof that shipments tracked by the geo-location system, for example, have not been tampered with, diverted or unsealed.

Public-key cryptography, in combination with one-way hash functions, can be used to confirm whether the geo-locator devices, and the environmental measurements stored thereon, were not tampered with. The geo-locator devices receive and store, in memory, public keys from a location and verification processor, which also stores private keys associated with the geo-locator devices. The devices can also receive, from the location and verification processor, unique seed numbers, from which hashed iterations are continually calculated using a one-way hash function. The hashed iterations of the seed number are paired with each iteration of the environmental measurements, and both are encrypted using the public keys. Parties attempting to tamper with the geo-locator devices by overwriting the environmental measurements will not have access to the original seed number, and thus will be unable to replicate the series of hashed iterations of the seed number stored along with the environmental measurements. As a result, the geo-locator devices are more secure from hacking, and the data thereon can be verified.

Information associated with the geo-locator devices can be stored and analyzed by the location and verification processor to further detect tampering or diversion. For example, shipment information, including the identification of a specific shipment in which a geo-locator device is included, and expected route information (like the origin of the shipment, the expected destination of the shipment, and/or an expected trajectory of the shipment) can be stored in a database and associated with specific geo-locator devices. Upon arrival of a geo-locator device at a destination, the calculated location history of all geo-locator devices in the same shipment can be compared to determine whether any of the geo-locator devices have been tampered with. Similarly, the location history associated with a geo-locator device can be compared to the expected location information associated with the same geo-locator device to determine whether the shipment containing that device has been diverted, or otherwise compromised.

Additionally, containers or packages containing the geo-locator devices can be sealed with a constant pressure, which is stored and associated with the geo-locator devices by the location and verification processor. The environmental measurements can then be analyzed to determine whether changes in the measured pressure indicate that the containers or packages were unsealed in transit.

In general, according to one aspect, the invention features a system for verifying supply chain integrity. The system comprises geo-locator devices, which include one or more sensors for generating environmental measurements. A controller generates hashed iterations of provided seed numbers using one-way hash functions and encrypts the environmental measurements and hashed iterations of the seed numbers, which are stored in memory. A location and verification processor receives and stores the environmental measurements and hashed iterations of the seed numbers from the geo-locator devices, and determines whether the environmental measurements are corrupted by comparing the series of hashed iterations of the seed numbers received from the geo-locator devices with an independent calculation of the series of hashed iterations of the same seed numbers using the same one-way hash functions.

In embodiments, a geo-locator information database stores seed numbers, encryption keys, shipment information, environmental measurements retrieved from the geo-locator devices, location histories, pressure information, and tampered, unsealed, diverted and/or verified status flags, for the geo-locator devices. The location histories are calculated by the location and verification processor comparing the environmental measurements retrieved from the geo-locator devices with publicly available environmental measurement and prediction databases. The sensors can include atmospheric pressure sensors, inertial sensors, temperature sensors, and magnetometers and AM/FM receivers. The environmental measurements and hashed iterations of the seed numbers are encrypted and decrypted using public keys and private keys associated with the geo-locator devices. The geo-locator devices do not store the original seed numbers in non-volatile memory, and the geo-locator devices overwrite the hashed iterations of the seed numbers with subsequent hashed iterations of the seed numbers. The geo-locater devices can further comprise write-once-read-many (WORM) memories for storing the encrypted environmental measurements and hashed iterations of the seed numbers.

In general, according to another aspect, the invention features a method for verifying supply chain integrity. Geo-locator devices calculate hashed iterations of seed numbers using a one way hash function, generate environmental measurements via one or more sensors, encrypt the environmental measurements and hashed iterations of the seed numbers, and store the encrypted environmental measurements and hashed iterations of the seed numbers in memory. Next, the location and verification processor retrieves and stores the environmental measurements and hashed iterations of the seed numbers from the geo-locator devices and determines whether the environmental measurements are corrupted by independently calculating the series of hashed iterations of the seed numbers using the one-way hash functions and comparing the independently calculated series with the series of hashed iterations of the same seed numbers received from the geo-locator devices.

In general, according to another aspect, the invention features a method for verifying supply chain integrity. A location and verification processor stores shipment information associated with geo-locator devices included in various shipments. The geo-locator devices generate environmental measurements via one or more sensors and store the environmental measurements in memory. The location and verification processor retrieves the environmental measurements from the geo-locator devices and calculates location histories of the geo-locator devices by comparing the environmental measurements to publicly available environmental measurement and prediction databases. Then, the location and verification processor determines whether the environmental measurements retrieved from the geo-locator devices are corrupted by comparing the location histories of geo-locator devices in the same shipment.

In general, according to another aspect, the invention features a method for verifying supply chain integrity. Shipments that include geo-locator devices are sealed in containers with a constant pressure, and a location and verification processor stores pressure information associated with the geo-locator devices. The geo-locator devices generate pressure measurements via atmospheric pressure sensors and store the pressure measurements in memory. The location and verification processor then retrieves the pressure measurements from the geo-locator devices and determines whether the containers were unsealed by comparing the pressure measurements retrieved from the geo-locator devices with the stored pressure information associated with the geo-locator devices.

In general, according to another aspect, the invention features a method for verifying supply chain integrity. A location and verification processor stores shipment information associated with geo-locator devices included in shipments. The shipment information includes expected route information. The geo-locator devices generate environmental measurements via one or more sensors and store the environmental measurements in memory. The location and verification processor then retrieves the environmental measurements from the geo-locator devices and calculates location histories of the geo-locator devices by comparing the environmental measurements to publicly available environmental measurement and prediction databases. The location and verification processor then determines whether the shipments in which the geo-locator devices were included were diverted by comparing the location histories associated with the geo-locator devices with the expected location information associated with the geo-locator devices.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram of a geo-location system constructed according to the principles of the current invention;

FIG. 2 is a block diagram of the geo-locator device;

FIG. 3 is a flow diagram showing how the encryption process running on the controller of the geo-locator device encrypts the environmental measurements; and

FIG. 4 is a flow diagram showing how the verification process running on the location and verification processor retrieves, decrypts, stores, and analyzes the environmental measurements.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

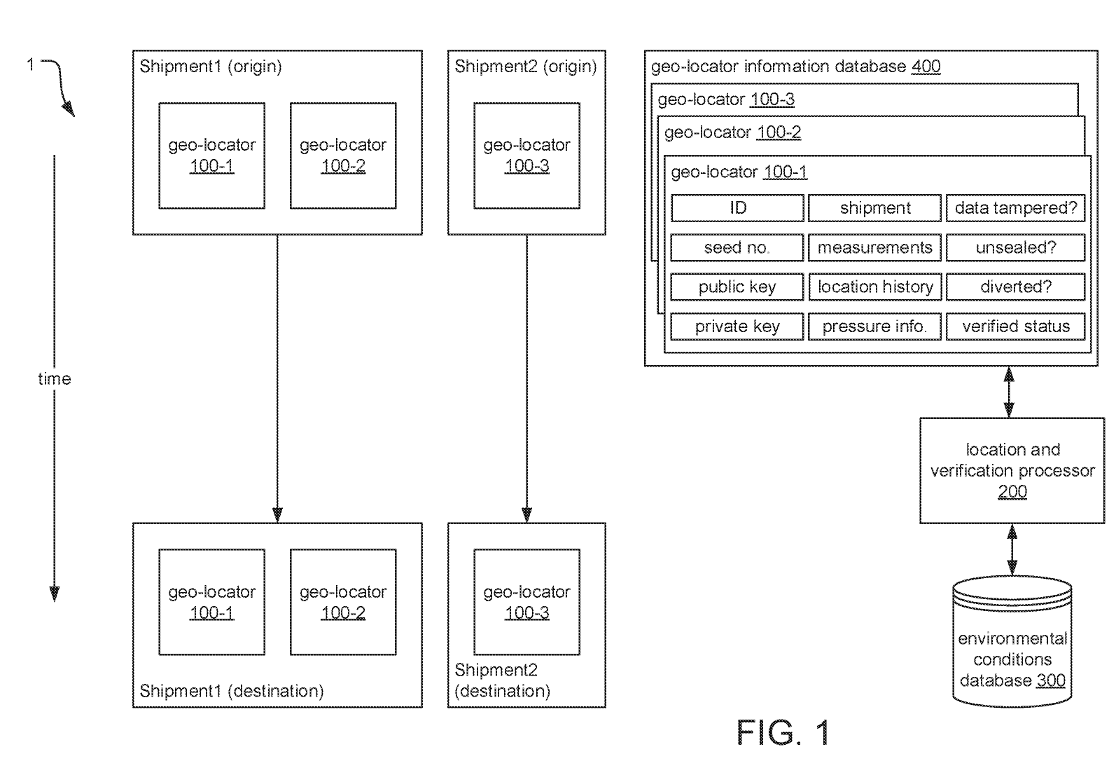

FIG. 1 is a block diagram of a geo-location system 1 constructed according to the principles of the current invention. The geolocation system 1 includes a location and verification processor 200, a geo-locator information database 400, an environmental conditions database 300, and two shipments containing three geo-locator devices 100-1, 100-2, 100-3.

In general, the location and verification processor 200 configures and then later retrieves information from the geo-locator devices 100-1, 100-2, 100-3 and stores it in the geo-locator information database 400. The location and verification processor 200 further calculates location histories based on information retrieved from the geo-locator devices 100, the geo-locator information database 400, and the environmental conditions database 300 and determines whether any of the shipments containing geo-locator devices 100 were tampered with, unsealed, and/or diverted.

In practice, the location and verification processor 200 might be a server or distributed server system, in different embodiments. the location and verification processor 200 configures the geo-locator devices 100 by having one or more cradles, for example, in which the geo-locator devices are loaded during a configuration operation and then later during a readout operation. In other embodiments, the cradle may be a handheld device with which the location and verification processor 200 communicates via a public network and/or a cellular network and/or enterprise network. In this way, technicians at a shipping container, for example, can take an un-configured geo-locator device 100, loaded it into the cradle and have it remotely configured by the location and verification processor 200.

The geo-locator information database 400 stores information pertaining to each of the geo-locator devices 100-1, 100-2, 100-3. For each device, the database includes an identification (such as a serial number), a seed number, which is a unique number assigned to each device for each shipment, one or more public keys, one or more corresponding private keys, shipment information (including an identification of the shipment containing the geo-locator devices 100-1, 100-2, 100-3, expected route information, an identification of the point of origin of the shipment, and an identification of the expected point of destination of the shipment), environmental measurements, location histories, pressure information, which is information about the pressure under which the container of the shipment has been sealed, an indication of whether data on the geo locator device 100 has been tampered with, an indication of whether the shipment containing the geo-locator device 100 has been unsealed, an indication of whether the shipment containing the geo-locator device 100 has been diverted, and an indication of whether the geo-locator device 100 is verified.

In general, the environmental conditions database 300 provides a set of data against which environmental measurements retrieved from the geo-locator devices 100 is compared and correlated in order to determine location histories for the devices. In embodiments, the environmental conditions database 300 utilizes publicly available data sets of gridded atmospheric pressure data, and may in fact be a publicly available database. Examples of sources of publicly available databases include the Rapid Update Cycle Surface Assimilation System maintained by the National Oceanic and Atmospheric Association, the Modern Era Retrospective—Analysis for Research and Applications maintained by the National Aeronautics and Space Administration, and datasets maintained by the European Centre for Medium-Range Weather Forecasts. The environmental conditions database 300 also includes data sets pertaining to other types of environmental measurements such as magnetic field, temperature, and/or radio frequency transmissions (including audio recordings based on AM/FM radio frequency transmissions (e.g., recording of commercial radio station broadcasts) and/or information about radio broadcasting stations such as broadcasting frequencies, locations and call signs, among other examples).

In the illustrated example, the geo-locator devices 100 are grouped into two different shipments (shipment1 and shipment2). More specifically, geo-locator device 100-1 and geo-locator device 100-2 are both grouped together in shipment1. Geo-locator device 100-3 is included in shipment2. Over time shipment1 and shipment2 both proceed from an origin point to a destination point.

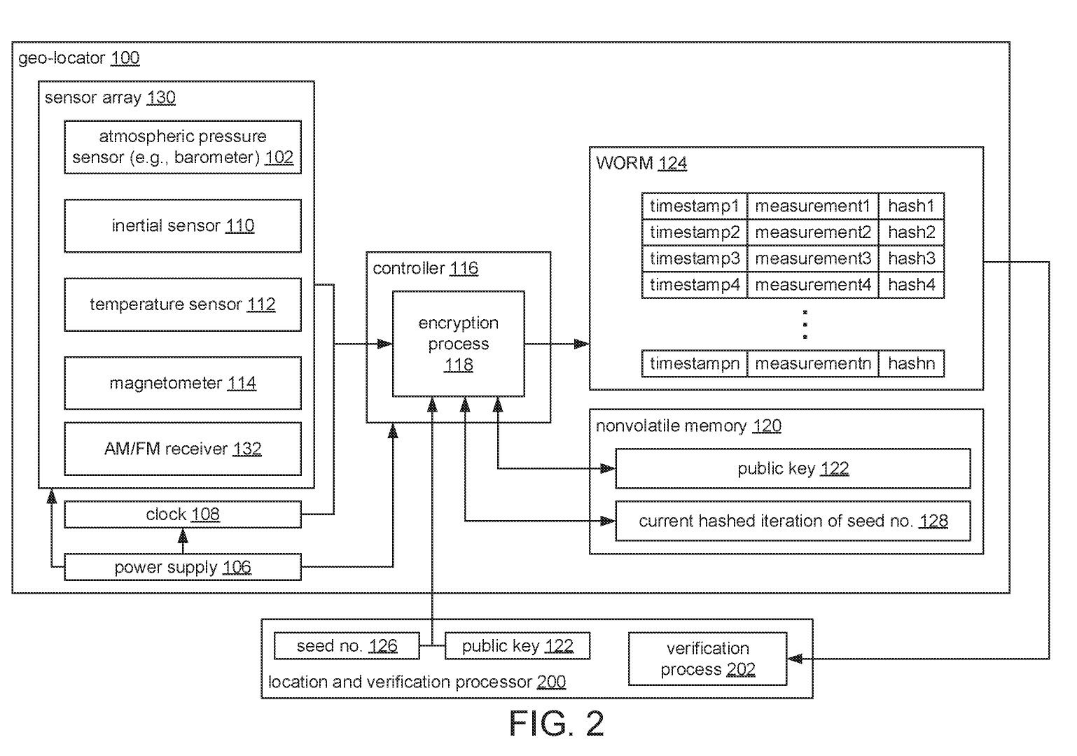

FIG. 2 is a block diagram of the geo-locator device 100. The geo-locator device 100 includes a sensor array 130, a clock 108, a power supply 106, a controller 116, non-volatile memory 120, and write-once-read-many (WORM) memory 124.

The power supply 106 provides power to the controller 116, the clock 108, and the sensor array 130.

The clock 108 sends timing information to the controller 116.

The sensor array 130 includes one or more of the following sensors: an atmospheric pressure sensor 102, an inertial sensor 110, a temperature sensor 112, a magnetometer 114, and an AM/FM radio receiver 132. The sensors 102, 110, 112, 114 generate environmental measurements and send the environmental measurements to the controller 116.

In general, the controller 116 receives environmental measurements from the sensor array 130, encrypts the environmental measurements, and stores the environmental measurements in the WORM memory 124.

At the point of origin for the shipment containing the geo-locator device 100, the location and verification processor 200 initializes the geo-locator device 100 in the configuration operation by providing it with a seed number 126 and the public key 122, both of which are associated with the geo-locator device 100 in the geo-locator information database 400. As described previously, in one specific example, the geo-locator device 100 is placed in a cradle of the location and verification processor 200 or in a cradle of a mobile device that is in communication with the location and verification processor 200.

An encryption process 118 running on the controller 116 of the geo-locator device 4100 receives the seed number 126 and the public key 122. The public key 122 is stored in non-volatile memory 120. The seed number 126, on the other hand, is not stored on the geo-locator device 100. Instead the encryption process 118 calculates an initial hashed iteration 128 of the seed number 126 using a one-way hash function and stores the initial hashed iteration 128 of the seed number 126 in non-volatile memory 120.

One-way hash functions are also known as cryptographic functions. Generally, they take arbitrary-sized input bit strings and output fixed-sized bit strings. The one-way function is designed to be infeasible to invert. Generally, only brute-force searches are possible to determine the input. Example functions include: BLAKE, BLAKE2, SHA-3, SHA-2, SHA-1, or MD5.

Once the geo-locator device 100 is initialized, on a continual basis, the encryption process 118 receives iterations of environmental measurements from the sensor array 130. In parallel, for each iteration of environmental measurements, the encryption process 118 calculates a subsequent hashed iteration 128 of the seed number 126 using the one-way function. The subsequent hashed iteration 128 of the seed number 126 is stored in non-volatile memory 120, and the previous hashed iteration 128 is overwritten with the subsequent one. Each iteration of environmental measurements is then grouped with the current hashed iteration 128 of the seed number 126 along with a timestamp, which is generated by the controller 116 based on timing information from the clock 108. The grouped data is then encrypted using the public key 122 and stored on the WORM 124.

At the point of destination of the shipment containing the geo-locator device 100, the encrypted timestamps, environmental measurements, and hashed iterations of the seed number 126 are then retrieved by a verification process 202 running on the location and verification processor 200. This read-out process is performed, in one example, by inserting the geo-locator devices 100 into a cradle of the location and verification processor 200 or of a mobile device that is connected to that processor 200. The verification process 202 decrypts the information, stores it in the geo-locator information database 400, and analyzes the information to determine a location history of the geo-locator device 100, as well as whether the geo-locator device 100, and/or the shipment containing the geo-locator device 100, has been tampered with, unsealed, or diverted.

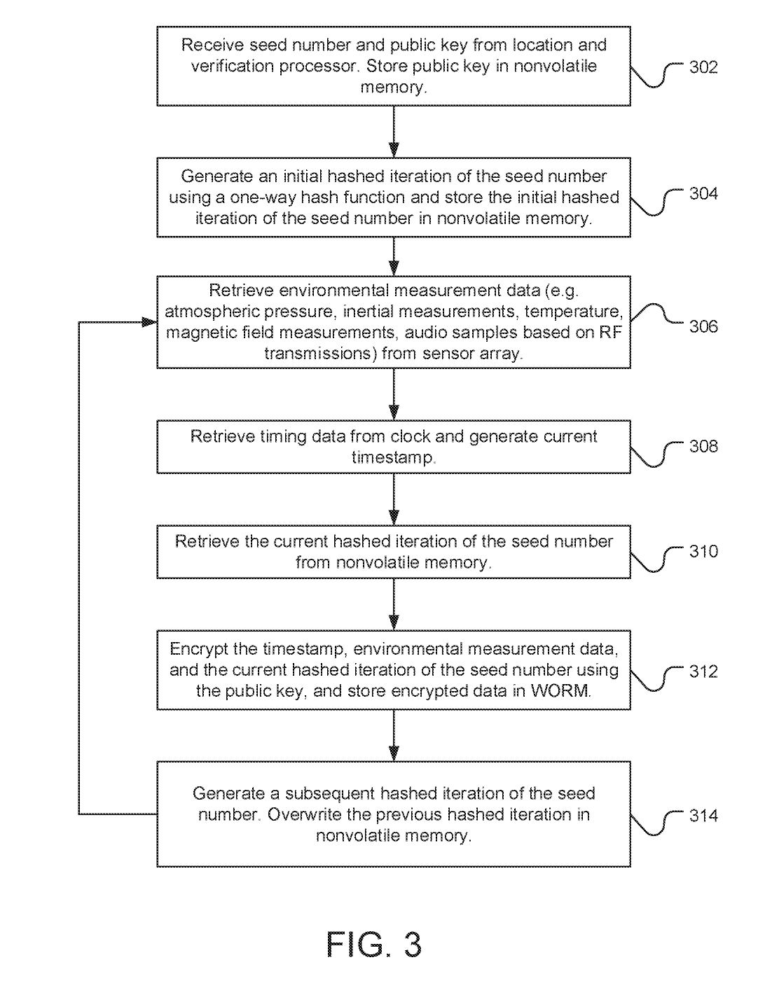

FIG. 3 is a flow diagram showing how the encryption process 118 running on the geo-locator device 100 encrypts the environmental measurements.

First in step 302, the geo-locator device 100 receives the seed number 126 and the public key 122 from the location and verification processor 200. The public key 122 is stored in non-volatile memory 120. In step 304, an initial hashed iteration 128 of the seed number 126 is generated using a one-way hash function, and the hashed iteration 128 is stored in non-volatile memory 120 in one case. In another case, the hashed iteration is not stored to the non-volatile memory 120. Instead, the hashed iteration is only stored in volatile memory such as a register of the controller 116 or another dynamic memory such as the controller's cache and or the DRAM of the controller 116. In this way, the hashed iteration will be lost if the controller 116 ever loses power.

Then, in step 306, the environmental measurements are retrieved from the sensor array 130. In step 308, timing information is retrieved from the clock 108, and a current timestamp is generated. In step 310, the current hashed iteration 128 of the seed number 126 is retrieved from non-volatile memory 120. In step 312, the timestamp, environmental measurements, and hashed iteration 128 of the seed number 126 are encrypted using the public key 122. The encrypted data is stored on the WORM 124.

In step 314, a subsequent hashed iteration 128 of the seed number 126 is generated and the previous hashed iteration 128 is overwritten.

The process then returns to step 306, as the environmental measurements are generated and encrypted on a continual basis, indefinitely.

In a typical embodiment, there may be a delay after step 314 that causes a delay before the flow returns to step 306. This delay ensures that the loop is processed at predetermined increments of time, such as every second, or every 10 seconds, or every minute, for example. In still other embodiments, the loop may run at longer time increments such as every 10 minutes or every hour.

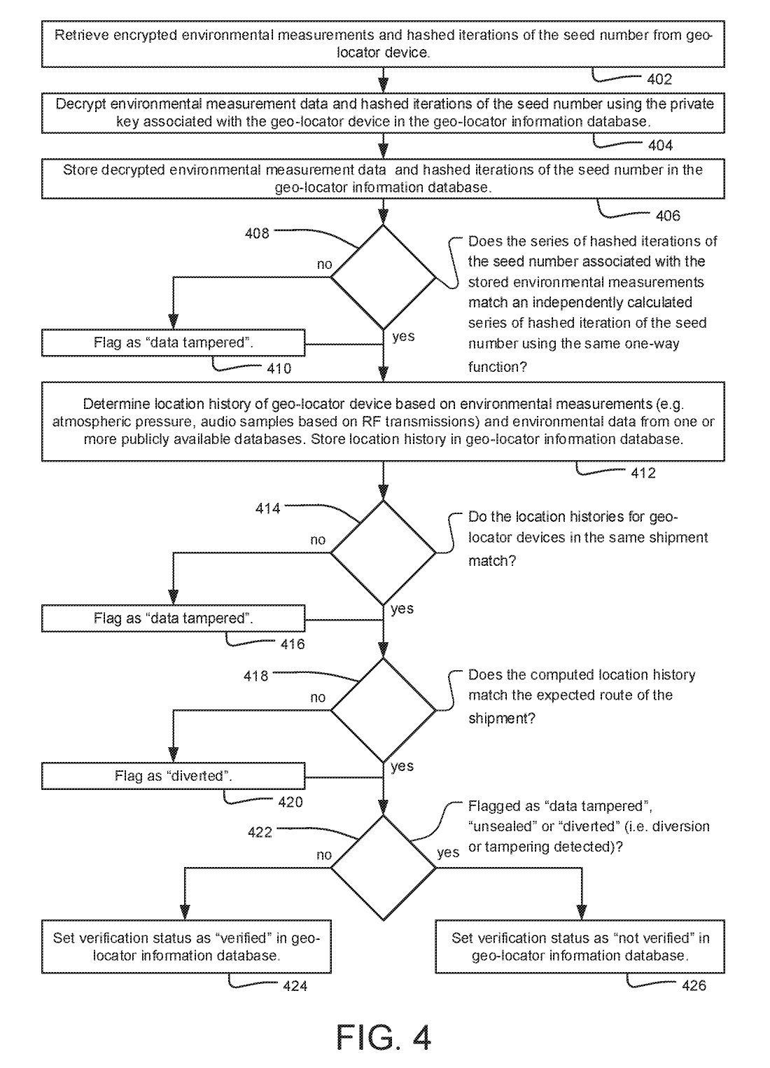

FIG. 4 is a flow diagram showing how the verification process 202 running on the location and verification processor 200 retrieves, decrypts, stores, and analyzes the environmental measurements.

First, in step 402, the encrypted environmental measurements, timestamps and hashed iterations 128 of the seed number 126 are retrieved from the geo-locator device 100. In step 404, the retrieved data is decrypted using the private key associated with the geo-locator device 100 in the geo-locator information database 400. The decrypted environmental measurement data and hashed iterations 128 of the seed number 126 are stored in the geo-locator information database 400 in step 406.

Then, in step 408, it is determined whether the series of hashed iterations 128 of the seed number 126 associated with the stored iterations of environmental measurements match an independently calculated series of hashed iterations of the seed number 126 using the same one-way function. If the series do not match, in step 410, the geo-locator device 100 is flagged as “data tampered”.

In step 412, a location history of the geo-locator device 100 is calculated based on a comparison of the environmental measurements with environmental data from the environmental conditions database 300. The location history is stored in the geo-locator information database 400.

On the other hand, in the scenario where the objective is to determine whether a sealed container was unsealed, the atmospheric or environmental pressure data from sensor 102 is compared against the expected pressure data associated with the shipment. Typically, when the shipping container is sealed with a predetermined pressure level, the pressure changes over the course of the shipment/time with changes in atmospheric pressure, environmental temperature, and possibly leakage of the pressure vessel. Then, the pressure data over time is analyzed to determine whether the shipping container was ever unsealed. Typically, in the case of unsealing, there will be a sharp change in the recorded pressure that is not correlated with a change in environmental temperature or atmospheric pressure.

In one example, the location history is generated based on a comparison of audio samples recorded by the geo-locator devices 100 based on radio-frequency transmissions received by and decoded by the AM/FM receiver 132 to audio samples based on radio-frequency transmissions and/or information about radio stations stored in the environmental conditions database 300. More specifically, identifying features of the audio samples recorded by the geo-locator devices 100, for specific broadcasting frequencies, station names, or call signs, are used to determine which metropolitan areas were nearest to the geo-locator devices 100 at the time of recording of the audio sample. For example, if the geo-locator device recorded a radio program that was broadcast from a radio station in New York City, then it can be concluded that the device was in that metropolitan region at that time.

Next, in step 414, it is determined whether the location histories for all of the geo-locator devices 100 included in the same shipment match. If not, in step 416, the geo-locator devices 100 are tagged as “data tampered”.

In step 418, it is determined whether the computed location history matches the expected route of the shipment associated with the geo-locator device 100 in the geo-locator information database 400. If not, the geo-locator device 100 is flagged as “diverted” in step 420.

In step 422, it is determined whether the geo-locator device 100 was flagged as either “data tampered”, “unsealed”, or “diverted”. If not, in step 424, the verification status for the geo-locator device 100 is set as “verified” in the geo-locator information database 400. On the other hand, if any of the flags has been set, in step 426, the verification status for the geo-locator device 100 is set as “not verified” in the geo-locator information database 400.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for verifying supply chain integrity, the system comprising:
geo-locator devices including one or more sensors for generating environmental measurements, a controller for generating hashed iterations of seed numbers using one-way hash functions and encrypting the environmental measurements and hashed iterations of the seed numbers, and memory for storing the encrypted environmental measurements and hashed iterations of the seed numbers; and
a location and verification processor for receiving and storing the environmental measurements and hashed iterations of the seed numbers from the geo-locator devices, and determining whether the environmental measurements are corrupted based on a comparison of the series of hashed iterations of the seed numbers received from the geo-locator devices with an independent calculation of the series of hashed iterations of the same seed numbers using the same one-way hash functions.

2. The system as claimed in claim 1, further comprising a geo-locator information database for storing seed numbers, encryption keys, shipment information, environmental measurements retrieved from the geo-locator devices, location histories, pressure information, and tampered, unsealed, diverted and/or verified status flags, for the geo-locator devices.

3. The system as claimed in claim 2, wherein the location histories are calculated by the location and verification processor comparing the environmental measurements retrieved from the geo-locator devices with publicly available environmental measurement and prediction databases.

4. The system as claimed in claim 1, wherein the one or more sensors comprise atmospheric pressure sensors.

5. The system as claimed in claim 1, wherein the one or more sensors comprise inertial sensors.

6. The system as claimed in claim 1, wherein the one or more sensors comprise temperature sensors.

7. The system as claimed in claim 1, wherein the one or more sensors comprise magnetometers.

8. The system as claimed in claim 1, wherein the one or more sensors comprise AM/FM receivers.

9. The system as claimed in claim 1, wherein the environmental measurements and hashed iterations of the seed numbers are encrypted and decrypted using public keys and private keys associated with the geo-locator devices.

10. The system as claimed in claim 1, wherein the geo-locator devices do not store the seed numbers in non-volatile memory.

11. The system as claimed in claim 1, wherein the geo-locator devices overwrite the hashed iterations of the seed numbers with subsequent hashed iterations of the seed numbers.

12. The system as claimed in claim 1, wherein the geo-locater devices further comprise write-once-read-many (WORM) memory for storing the encrypted environmental measurements and hashed iterations of the seed numbers.

13. A method for verifying supply chain integrity, the method comprising:
geo-locator devices calculating hashed iterations of seed numbers using a one way hash function, generating environmental measurements via one or more sensors, encrypting the environmental measurements and hashed iterations of the seed numbers, and storing the encrypted environmental measurements and hashed iterations of the seed numbers in memory; and
a location and verification processor retrieving and storing the environmental measurements and hashed iterations of the seed numbers from the geo-locator devices, and determining whether the environmental measurements are corrupted by independently calculating the series of hashed iterations of the seed numbers using the one-way hash functions and comparing the independently calculated series with the series of hashed iterations of the same seed numbers received from the geo-locator devices.

14. The method as claimed in claim 13, further comprising the location and verification processor storing seed numbers, encryption keys, shipment information, environmental measurements retrieved from the geo-locator devices, location histories, pressure information, and tampered, unsealed, diverted and/or verified status flags for the geo-locator devices in a geo-locator information database.

15. The method as claimed in claim 14, further comprising the location and verification processor calculating the location histories by comparing the environmental measurements retrieved from the geo-locator devices with publicly available environmental measurement and prediction databases.

16. The method as claimed in claim 13, further comprising atmospheric pressure sensors generating the environmental measurements.

17. The method as claimed in claim 13, further comprising inertial sensors generating the environmental measurements.

18. The method as claimed in claim 13, further comprising temperature sensors generating the environmental measurements.

19. The method as claimed in claim 13, further comprising magnetometers generating the environmental measurements.

20. The method as claimed in claim 13, further comprising AM/FM receivers generating the environmental measurements.

21. The method as claimed in claim 13, further comprising the geo-locator devices and location and verification processors encrypting and decrypting the environmental measurements and hashed iterations of the seed numbers using public keys and private keys associated with the geo-locator devices.

22. The method as claimed in claim 13, further comprising the geo-locator devices not storing the seed numbers in memory.

23. The method as claimed in claim 13, further comprising the geo-locator devices overwriting the hashed iterations of the seed numbers with subsequent hashed iterations of the seed numbers.

24. The method as claimed in claim 13, further comprising the geo-locater devices storing the encrypted environmental measurements and hashed iterations of the seed numbers in write-once-read-many (WORM) memory.

25. A method for verifying supply chain integrity, the method comprising:
a location and verification processor storing shipment information associated with geo-locator devices included in shipments;
the geo-locator devices generating environmental measurements via one or more sensors and storing the environmental measurements in memory;
the location and verification processor retrieving the environmental measurements from the geo-locator devices and calculating location histories of the geo-locator devices by comparing the environmental measurements to publicly available environmental measurement and prediction databases and determining whether the environmental measurements retrieved from the geo-locator devices are corrupted by comparing the location histories of geo-locator devices in the same shipment.

26. A method for verifying supply chain integrity, the method comprising:
sealing shipments including geo-locator devices in containers with a constant pressure;
a location and verification processor storing pressure information associated with the geo-locator devices;
the geo-locator devices generating pressure measurements via atmospheric pressure sensors and storing the pressure measurements in memory;
the location and verification processor retrieving the pressure measurements from the geo-locator devices and determining whether the containers were unsealed by comparing the pressure measurements retrieved from the geo-locator devices with the stored pressure information associated with the geo-locator devices.

27. A method for verifying supply chain integrity, the method comprising:
a location and verification processor storing shipment information associated with geo-locator devices included in shipments, the shipment information further including expected route information;
the geo-locator devices generating environmental measurements via one or more sensors and storing the environmental measurements in memory;
the location and verification processor retrieving the environmental measurements from the geo-locator devices and calculating location histories of the geo-locator devices by comparing the environmental measurements to publicly available environmental measurement and prediction databases and determining whether the shipments in which the geo-locator devices were included were diverted by comparing the location histories associated with the geo-locator devices with the expected location information associated with the geo-locator devices.
